(19) United States
(12) Patent Application Publication
(10) Pub. No.: US 2012/0119446 A1
(43) Pub. Date: May 17, 2012

(54) SEALING UNIT FOR CONTROLLED LUBRICATION FLOW

(75) Inventors: Marion Jack Ince, Mount Holly, NC (US); Joseph T. Griffin, Matthews, NC (US); Eric Clark, Rock Hill, SC (US)

(73) Assignee: SCHAEFFLER TECHNOLOGIES GMBH & CO. KG, Herzogenaurach (DE)

(21) Appl. No.: 13/298,710

(22) Filed: Nov. 17, 2011

Related U.S. Application Data
(60) Provisional application No. 61/414,632, filed on Nov. 17, 2010.

(51) Int. Cl. F16J 15/32; F16J 15/00

(52) U.S. Cl. 277/549; 277/500

(57) ABSTRACT

A sealing unit for sealing a shaft to a housing includes a sealing ring with a first surface for non-rotational engagement with the housing and a flow groove including an axially aligned portion at least partially disposed in the first surface. In some example embodiments, the sealing ring includes a second surface for sealing engagement with the shaft. In an example embodiment, the sealing ring includes a rectangular cross-section, in a radial plane, with first and second axially opposed radial faces, and the flow groove includes a radially aligned portion at least partially disposed in the first and second radial faces. In an example embodiment, the sealing ring has a circular cross-section, in a radial plane, with a center point, and a depth of the groove is greater at a radial line passing through the center point than at a radial line tangent to the sealing ring.

### FIELD

The invention relates generally to a seal, and more specifically to a sealing unit for controlled lubrication flow.

### BACKGROUND

Pressurized lubrication circuits in automatic transmissions may flow directly to a bearing, or the bearing may be positioned just off the main line of flow. Bearing seals typically seal completely and could allow lubricant to stagnate within the bearing. That is, if the bearing is sealed on the opposite end to maintain system pressure, the lubrication is trapped, or prevented from flowing through the bearing, retaining lubricant within the bearing. If this lubrication becomes stagnated, the lubricant properties necessary for the intended application may degrade, resulting in premature bearing failure.

Known seal leakage holes are positioned on a seal lip adjacent to a moveable part, compromising lip integrity. Furthermore, known restrictor rings may result in interference with mating components and are prone to rotate, leading to sealing bore wear and changing flow characteristics. Also, rings typically allow too little or too much lubrication flow between the ring bore and shaft surface. Prior art seals are shown in U.S. Pat. Nos. 4,123,068 to Van Gorder and 6,029,980 to Downes, and commonly-assigned United States Patent Application Publication No. 2008/0111317 to Walter et al.

### BRIEF SUMMARY

Example aspects broadly comprise a sealing unit for sealing a shaft to a housing including a sealing ring with a first surface for non-rotational engagement with the housing and a flow groove including an axially aligned portion at least partially disposed in the first surface. In some example embodiments, the sealing ring includes a second surface for sealing engagement with the shaft. In an example embodiment, the sealing ring includes a rectangular cross-section, in a radial plane, with first and second axially opposed radial faces, and the flow groove includes a radially aligned portion at least partially disposed in the first and second radial faces. In an example embodiment, the sealing ring has a circular cross-section, in a radial plane, with a center point, and a depth of the groove is greater at a radial line passing through the center point than at a radial line tangent to the sealing ring.

In some example embodiments, the sealing ring is a lip seal with a central axis aligned with a central axis of the shaft, the lip seal includes a conical protrusion extending about the lip seal axis, and the conical protrusion is sealingly engaged with the shaft. In an example embodiment, the sealing unit has a friction-reducing lip material, bonded to the conical protrusion and sealingly engaged with the shaft. In an example embodiment, the sealing ring includes first and second oppositely facing radial faces, and the flow groove includes first and second radially aligned portions disposed in the first and second radial faces, respectively.

Other example aspects broadly comprise a seal for sealing a rotary shaft to a housing including a sealing portion for sealing to the rotary shaft, and a flow control portion, separate from the sealing portion, including an axial flow path between the seal and the housing. In an example embodiment the housing is a transmission housing, the seal is arranged for assembly in a bore of the housing, and the flow path is disposed between the seal and the bore. In an example embodiment, the housing is a transmission housing, the seal is arranged for assembly on a protrusion of the housing, and the flow path is disposed between the seal and the protrusion. In an example embodiment, the housing is a drawn bearing cup, the seal is arranged for assembly in a bore of the cup, and the flow path is disposed between the seal and the bore.

Other example aspects broadly comprise a sealing unit including a sealing ring with a circumferential surface for engagement with a first component, a first radial surface, and a flow groove. The flow groove has a first portion disposed in the circumferential surface and a second portion disposed in the first radial surface and in communication with the first portion. In an example embodiment, the circumferential surface includes a radially outer circumferential surface arranged for non-rotational engagement with a first component. In an example embodiment, the sealing ring includes a second radial surface and the flow groove includes a third portion disposed in the second radial surface and in communication with the first portion.

### BRIEF DESCRIPTION OF THE DRAWINGS

The nature and mode of operation of the present invention will now be more fully described in the following detailed description taken with the accompanying drawing figures, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is a partial front view of a ring seal including a flow groove according to an example aspect;

FIG. 3 is a section view of the ring seal of FIG. 2 taken generally along line 3-3 in FIG. 2;

FIG. 4 is a partial front view of an o-ring seal including a flow groove according to an example aspect;

FIG. 5 is a section view of the ring seal of FIG. 4 taken generally along line 5-5 in FIG. 4;

FIG. 6 is a front view of a lip seal including a flow groove according to an example aspect;

FIG. 7 is a section view of the lip seal of FIG. 6 taken generally along line 7-7 in FIG. 6;

FIG. 8 is a partial section view of a lip seal and a shaft shown installed in a housing.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

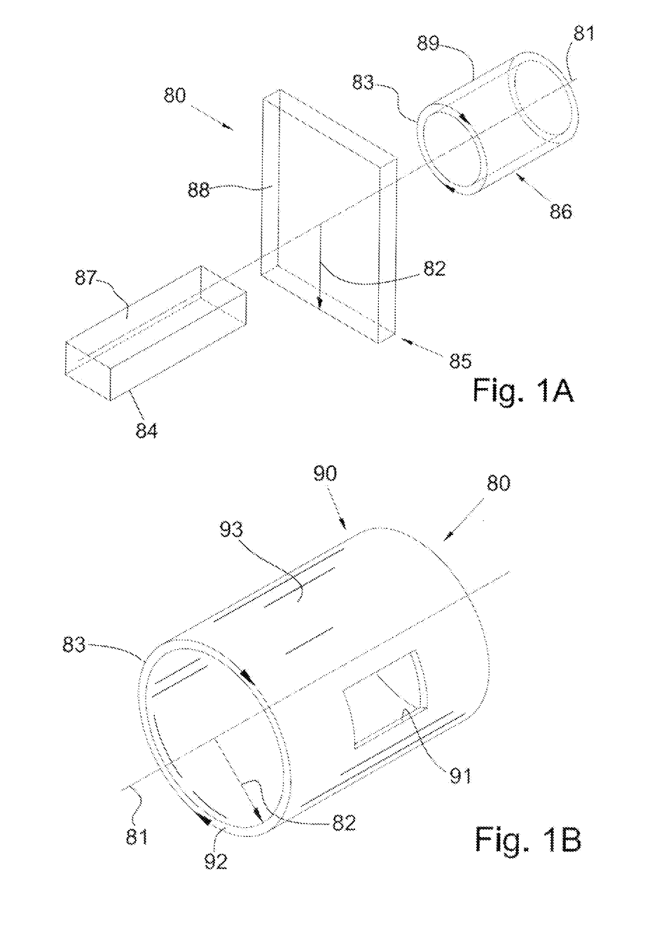

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is part of a circumferential plane.

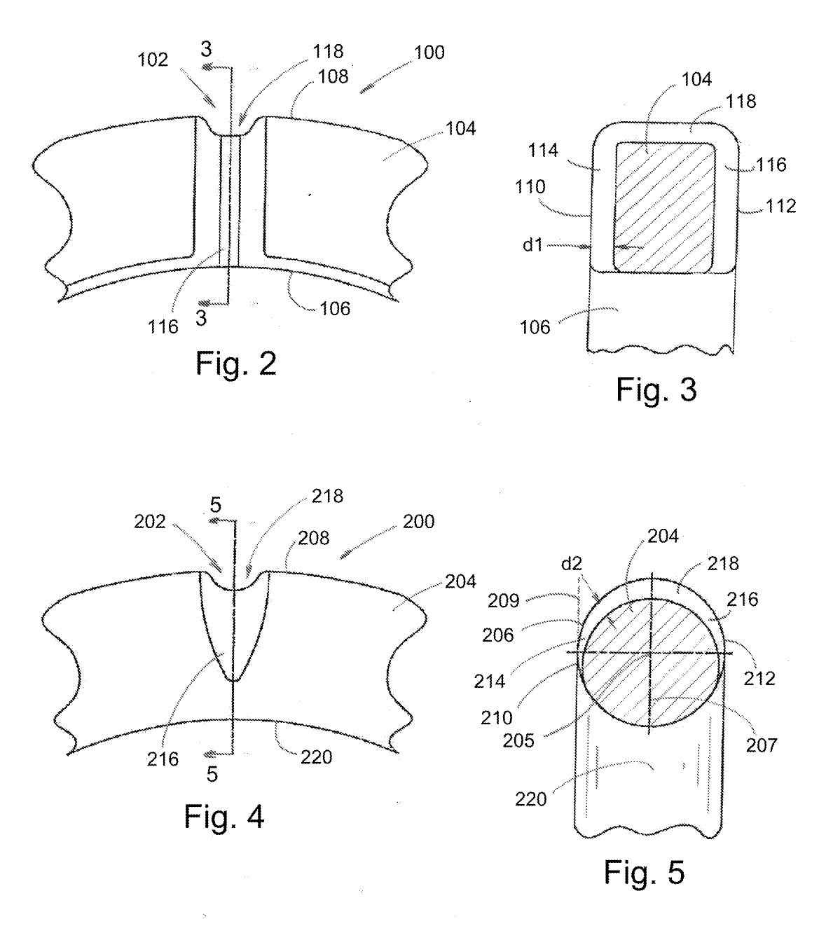

The following description is made with reference to FIGS. 2-3. FIG. 2 is a partial front view of ring seal 100 including flow groove 102 according to an example aspect. FIG. 3 is a section view of ring seal 100 of FIG. 2 taken generally along line 3-3 in FIG. 2. Ring seal 100 includes sealing ring 104 with a rectangular cross section including circumferential sealing surfaces, or faces, 106 and 108, and radial surfaces, or faces, 110 and 112. Flow groove 102 is disposed in sealing faces 108, 110, and 112 to provide continuous lubrication flow and limit lubricant stagnation as further described below.

Flow groove 102 includes radially aligned portions 114 and 116 disposed in respective radial faces 110 and 112 of the sealing ring, and axially aligned portion 118 disposed on outer surface 108 of the sealing ring. Depth dl of groove 102 is shown relatively constant in FIGS. 2 and 3, although varying depths of groove 102 are possible. Similarly, the number of grooves, groove size, and groove geometry can be selected according to system lubrication pressure and required flow. For example, more grooves give more flow, while fewer grooves may be necessary to achieve similar flow at increased lubrication pressure. Groove features may be molded, formed, or machined on to the sealing ring, depending on sealing ring material.

The following description is made with reference to FIGS. 4-5. FIG. 4 is a partial front view of o-ring seal 200 including flow groove 202 according to an example aspect. FIG. 5 is a section view of ring seal 200 of FIG. 4 taken generally along line 5-5 in FIG. 4. O-ring seal 200 includes sealing ring 204 with toroidal sealing surface, or face, 206. Flow groove 202 is disposed about sealing face, or outer diameter 208 of sealing surface 206 to provide continuous lubrication and limit lubricant stagnation. Flow groove 202 includes radial grooves 214 and 216 disposed on respective radial portions of toroidal surface 206, and axial groove 218 disposed on outer diameter 208 of the sealing ring.

Depth d2 of groove 202 is variable as it extends around toroidal surface 204. That is, groove 202 is deepest at portion 218 on outer diameter 208 and gradually tapers to zero depth at circumferential extremes of portions 214 and 216. As shown in FIG. 5, ring 204 has a circular cross section, in a radial plane, with center point 205. Depth d2 or groove 202 is greater at radial line 207 passing through point 205 than at radial line 209 tangent to the sealing ring. Other variations of groove 202 are possible, depending on the application. For example, groove depth d2 may be deepest at portion 214 and/or 216 and taper to zero at portion 218 and/or inner diameter portion 220.

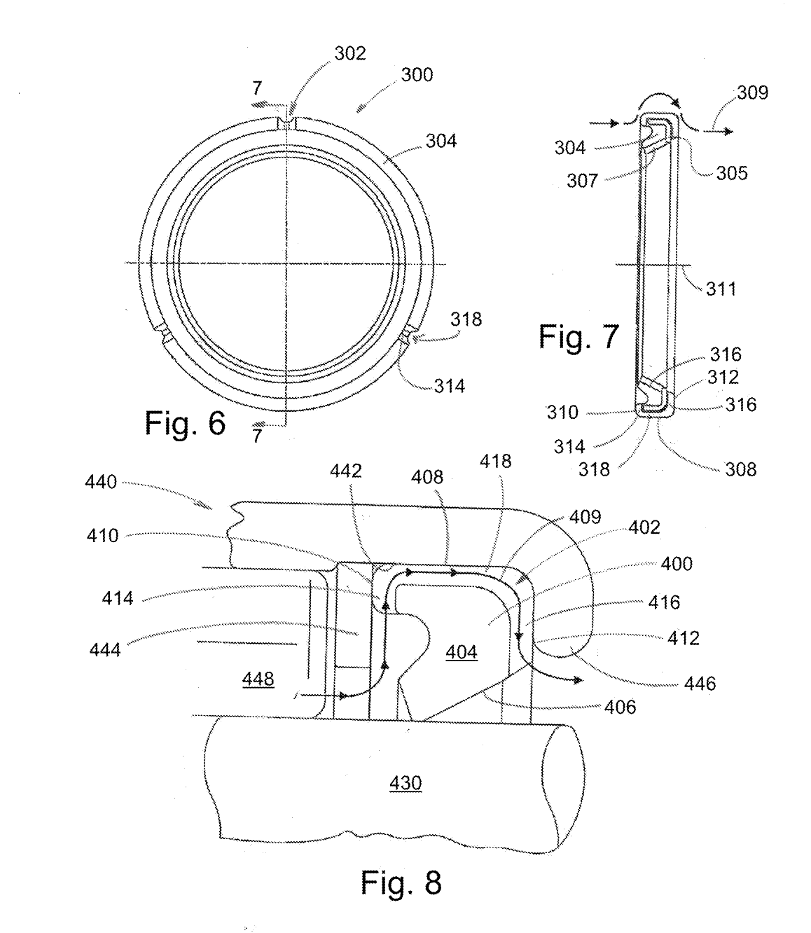

The following description is made with reference to FIGS. 6-7. FIG. 6 is a front view of lip seal 300 including flow groove 302 according to an example aspect. FIG. 7 is a section view of lip seal 300 of FIG. 6 taken generally along line 7-7 in FIG. 6. Sealing ring 304 forms a portion of lip seal 300. Lip seal 300 also includes steel insert 305 and bonded friction reducing lip material 307. Insert 305 is molded into ring 304, and material 307 may be fixed to the ring by chemical or adhesive bonding, for example.

Sealing ring 304 includes conical sealing surface, or protrusion, 306, circumferential sealing surface, or face 308, and radial surfaces, or faces, 310 and 312. Seal 300 includes central axis 311 and protrusion 306 extends about axis 311. In an example embodiment, material 307 is attached at surface 306. Flow groove 302 is disposed in sealing faces 308, 310, and 312 to provide continuous lubrication and limit lubricant stagnation, as indicated by arrows 309. Flow groove 302 includes radially aligned portions 314 and 316 disposed in respective radial faces 310 and 312 of the sealing ring, and axially aligned portion 318 disposed in outer diameter 308 of the sealing ring.

The following description is made with reference to FIG. 8. FIG. 8 is a partial section view of lip seal 400 with flow groove, or flow control portion, 402, and shaft 430, shown installed in housing 440. Sealing ring, or flow-seal core, 404 forms a portion of lip seal 400. Sealing ring 404 includes circumferential sealing surface, or face, 406 installed in housing 440, conical sealing surface 408 engaged with shaft 430, and radial surfaces, or faces, 410 and 412. Flow groove 402 is disposed about sealing faces 408, 410, and 412 to provide continuous lubrication and limit lubricant stagnation. Flow groove 402 includes radially aligned portions 414 and 416 disposed in respective radial faces 410 and 412 of the sealing ring, and axially aligned portion, or axial flow path, 418 disposed in outer diameter 408 of the sealing ring so that a controlled flow of lubricant is directed past the seal as indicated by arrow 409.

Lip seal 400 is press-fit into housing bore 442. That is, outer face, or diameter, 408 is compressively fitted, or press-fit into bore 442. Similarly, inner surface 406 is compressively fitted on shaft 430, although with less compression than the fit of diameter 408 in bore 442. In an example embodiment, a central axis of seal 400 (similar to axis 311 for seal 300 in FIG. 7) is aligned with a central axis of the shaft (not shown). Conical surface 406 is easily deflectable so that shaft 430 is rotatable relative to seal 400 and bore 442, but friction at the interface may result in wear of surface 406. Without a groove, seal 400 would prevent flow of fluid between shaft 430 and housing 440.

The press-fit, or interference fit, between diameter 408 and bore 442 prevents rotation of the sealing unit relative to the housing, thereby eliminating the possibility of wear and maintaining flow consistency. That is, because there is no relative rotation between the housing and the seal, diameter 408, and depth of groove 402, remains consistent.

Radial faces may be disposed adjacent to another component or a housing shoulder. For example, in FIG. 8, face 410 is disposed adjacent retaining washer 444 and face 412 is disposed adjacent rolled lip 446. The grooves allow lubrication to flow through the radial faces and around the outer diameter of the sealing unit. Otherwise stated, flow control portion 402 includes axial flow path 418 disposed between seal 400 and housing 440, or, more specifically, between seal 400 and bore 442. As shown in FIG. 8, housing 440 is a drawn cup for a bearing that includes roller 448.

Advantages of the described sealing unit include the ability to provide controlled leakage to prevent stagnation of the lubricant within the bearing, and prevent consequent loss of lubricant qualities. That is, the sealing unit allows fresh lubrication to flow through the bearing at a controlled rate while retaining system pressure, resulting in longer bearing life. The sealing unit routes lubrication around its outer diameter, maintaining seal lip integrity.

Other advantages include the ability to operate as a dam to maintain a quantity of lubrication on one side of the sealing unit, and to provide controlled leakage through the sealing unit to lubricate other areas of the system. Flow rate is not subject to change due to wear, and flow characteristics are controlled. The described sealing unit is easily incorporated into new designs, and is within typical seal component envelope dimensions.

Although specific applications of the sealing unit are described, other applications may exist and should be considered within the scope of the invention. For example, the sealing unit may be used as an internal component to a radial bearing, be incorporated into an axial bearing, or may be a stand-alone unit. Typical applications include automotive transmissions using Automatic Transmission Fluid (ATF).

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. A sealing unit for sealing a shaft to a housing comprising:
a sealing ring including:
a first surface for non-rotational engagement with the housing; and,
a flow groove including an axially aligned portion at least partially disposed in the first surface.

2. The sealing unit of claim 1 wherein the sealing ring includes a second surface for sealing engagement with the shaft.

3. The sealing unit of claim 2 wherein:
the sealing ring includes a rectangular cross-section, in a radial plane, with first and second axially opposed radial faces; and,
the flow groove includes a radially aligned portion at least partially disposed in the first and second radial faces.

4. The sealing unit of claim 2 wherein:
the sealing ring has a circular cross-section, in a radial plane, with a center point; and,
a depth of the groove is greater at a radial line passing through the center point than at a radial line tangent to the sealing ring.

5. The sealing unit of claim 2 wherein:
the sealing ring is a lip seal with a central axis aligned with a central axis of the shaft;
the lip seal includes a conical protrusion extending about the lip seal axis; and,
the conical protrusion is sealingly engaged with the shaft.

6. The sealing unit of claim 5, wherein the sealing unit comprises a friction-reducing lip material, bonded to the conical protrusion and sealingly engaged with the shaft.

7. The sealing unit of claim 1, wherein:
the sealing ring includes first and second oppositely facing radial faces; and,
the flow groove comprises first and second radially aligned portions disposed in the first and second radial faces, respectively.

8. A seal for sealing a rotary shaft to a housing including:
a sealing portion for sealing to the rotary shaft; and,
a flow control portion, separate from the sealing portion, including an axial flow path between the seal and the housing.

9. The seal of claim 8 wherein the housing is a transmission housing, the seal is arranged for assembly in a bore of the housing, and the flow path is disposed between the seal and the bore.

10. The seal of claim 8 wherein the housing is a transmission housing, the seal is arranged for assembly on a protrusion of the housing, and the flow path is disposed between the seal and the protrusion.

11. The seal of claim 8 wherein the housing is a drawn bearing cup, the seal is arranged for assembly in a bore of the cup, and the flow path is disposed between the seal and the bore.

12. A sealing unit comprising a sealing ring including:
a circumferential surface for engagement with a first component;
a first radial surface; and,
a flow groove with:
a first portion disposed in the circumferential surface; and,
a second portion disposed in the first radial surface and in communication with the first portion.

13. The sealing unit of claim 12 wherein the circumferential surface includes a radially outer circumferential surface arranged for non-rotational engagement with a first component.

14. The sealing unit of claim 12, wherein:
the sealing ring includes a second radial surface; and,
the flow groove includes a third portion disposed in the second radial surface and in communication with the first portion.
